(19) United States
(12) Patent Application Publication
(10) Pub. No.: US 2012/0039095 A1
(43) Pub. Date: Feb. 16, 2012

(54) BOOST CONVERTER

(75) Inventors: Hyo Young KIM, Suwon (KR); Jong Rak KIM, Suwon (KR); Sung Hun OH, Suwon (KR); Jeong Hyun PARK, Suwon (KR)

(73) Assignee: SAMSUNG ELECTRO-MECHANICS CO., LTD., Gyunggi-do (KR)

(21) Appl. No.: 13/114,123

(22) Filed: May 24, 2011

(30) Foreign Application Priority Data
Aug. 12, 2010 (KR) 10-2010-0077737

(51) Int. Cl. H02M 3/335

(52) U.S. Cl. 363/21.04

(57) ABSTRACT

There is provided a boost converter capable of reducing internal pressure in elements without the employment of a separate snubber by clamping a voltage, transmitted to the elements, to a charging voltage or an output voltage during power conversion. The boost converter includes a transformer including a primary winding receiving input power and a secondary winding electromagnetically coupled to the primary winding and having a predetermined turns ratio therewith; a switching part allowing the input power transmitted to the primary winding to be on or off according to a predetermined switching duty; a clamping part including a link capacitor charged with the input power obtained when the switching part is switched on, and power transformed based on the predetermined turns ratio; and a stabilizing part stabilizing power outputted from the clamping part.

### CROSS-REFERENCE TO RELATED APPLICATIONS

This application claims the priority of Korean Patent Application No. 10-2010-0077737 filed on Aug. 12, 2010, in the Korean Intellectual Property Office, the disclosure of which is incorporated herein by reference.

### BACKGROUND OF THE INVENTION

1. Field of the Invention

The present invention relates to a boost converter, and more particularly, to a boost converter capable of reducing internal pressure in elements without the employment of a separate snubber by clamping a voltage, transmitted to the elements, to a charging voltage or an output voltage during power conversion.

2. Description of the Related Art

In recent years, a variety of power supply devices capable of boosting low DC voltage have been being developed for an electric drive system using a fuel cell or a battery, semiconductor manufacturing equipment, large-sized display devices, ultrasonic and X-ray devices, and the like.

In the case of such power supply devices, a boost converter may be a representative power supply device.

It can be difficult to obtain a high boost ratio in a general boost converter, and therefore, a plurality of series-connected boost converters have conventionally been used to obtain a high boost ratio. However, this leads to a reduction in power conversion efficiency and an increase in unit costs due to an increase in utilized components.

In order to solve these problems, a boost converter employing a tapped inductor has been used; however, it is necessary to employ a snubber so as to reduce the incidence of a surge voltage caused during power conversion switching.

Since this snubber also leads to a reduction of power conversion efficiency and to the incidence of a surge voltage, it is necessary to employ elements having high internal pressure, which results in an increase in manufacturing costs.

### SUMMARY OF THE INVENTION

An aspect of the present invention provides a boost converter capable of reducing internal pressure in elements without the employment of a separate snubber by clamping a voltage, transmitted to the elements, to a charging voltage or an output voltage during power conversion.

According to an aspect of the present invention, there is provided a boost converter including: a transformer including a primary winding receiving input power and a secondary winding electromagnetically coupled to the primary winding and having a predetermined turns ratio therewith; a switching part allowing the input power transmitted to the primary winding to be on or off according to a predetermined switching duty; a clamping part including a link capacitor charged with the input power obtained when the switching part is switched on, and power transformed based on the predetermined turns ratio; and a stabilizing part stabilizing power outputted from the clamping part.

A sum of a voltage level of power magnetically induced from the primary winding to the secondary winding and a voltage level of the input power may be greater than a voltage level of power charged in the link capacitor.

The transformer may further include a leakage inductor series-connected between one end of the primary winding and one end of an input power terminal through which the input power is transmitted; and a magnetizing inductor parallel-connected to one end and the other end of the primary winding.

The switching part may include a switch connected between the other end of the primary winding and a ground, and the clamping part may further include a first diode having an anode connected to the other end of the primary winding and a cathode connected to one end of the secondary winding; and a second diode having an anode connected to one end of the input power terminal and a cathode connected to the other end of the secondary winding.

The stabilizing part may include a third diode having an anode connected to the other end of the secondary winding; and a capacitor connected to a cathode of the third diode and the ground.

The primary winding and the secondary winding may be wound in the same direction.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating the configuration of a boost converter according to an exemplary embodiment of the present invention;

FIG. 2 is a view schematically illustrating current flowing in a boost converter according to an exemplary embodiment of the present invention;

FIG. 3 is a view schematically illustrating current flowing in an equivalent circuit of a boost converter, when a switch is switched on, according to an exemplary embodiment of the present invention;

FIG. 4 is a view schematically illustrating current flowing in an equivalent circuit of a boost converter, when a switch is switched off, according to an exemplary embodiment of the present invention; and

FIG. 5 is a graph illustrating a voltage level applied to a secondary winding employed in a boost converter, when a switch is switched on and off, according to an exemplary embodiment of the present invention.

### DETAILED DESCRIPTION OF THE PREFERRED EMBODIMENT

Exemplary embodiments of the present invention will now be described in detail with reference to the accompanying drawings.

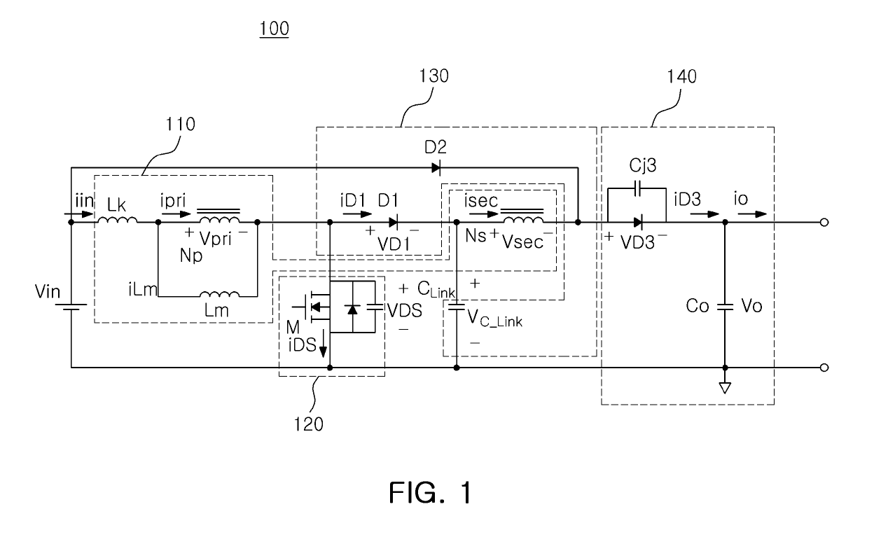

FIG. 1 is a schematic view illustrating the configuration of a boost converter according to an exemplary embodiment of the present invention.

With reference to FIG. 1, a boost converter 100 may include a transformer 110, a switching part 120, a clamping part 130, and a stabilizing part 140.

The transformer 110 may include a primary winding Np and a secondary winding Ns. The primary winding Np and the secondary winding Ns may be electromagnetically coupled to each other and form a predetermined turns ratio therebetween. The primary winding and the secondary winding may be wound in the same direction.

The switching part 120 may include a switch M switching input power transmitted to the primary winding Np according to a predetermined switching duty.

The clamping part 130 may include first and second diodes D1 and D2 transmitting power and a link capacitor C_{Link}.

The stabilizing part 140 may include a third diode D3 and a capacitor Co causing output power to be stabilized.

One end of the primary winding Np of the transformer 110 may be connected to one end of an input power terminal, through which input power Vin is inputted, and the other end of the primary winding Np may be connected to one end of the switch M of the switching part 120. The other end of the switch M may be connected to a ground. The first diode D1 may have an anode connected to one end of the switch M and a cathode connected to one end of the link capacitor C_{Link}. The other end of the link capacitor C_{Link} may be connected to the ground. One end of the secondary winding Ns may be connected to one end of the link capacitor C_{Link}. The second diode D2 may have an anode connected to one end of the input power terminal and a cathode connected to the other end of the secondary winding Ns. The third diode D3 may have an anode connected to the other end of the secondary winding Ns and a cathode connected to one end of the capacitor Co. The other end of the capacitor Co may be connected to the ground. The primary winding and the secondary winding may be wounded in the same direction

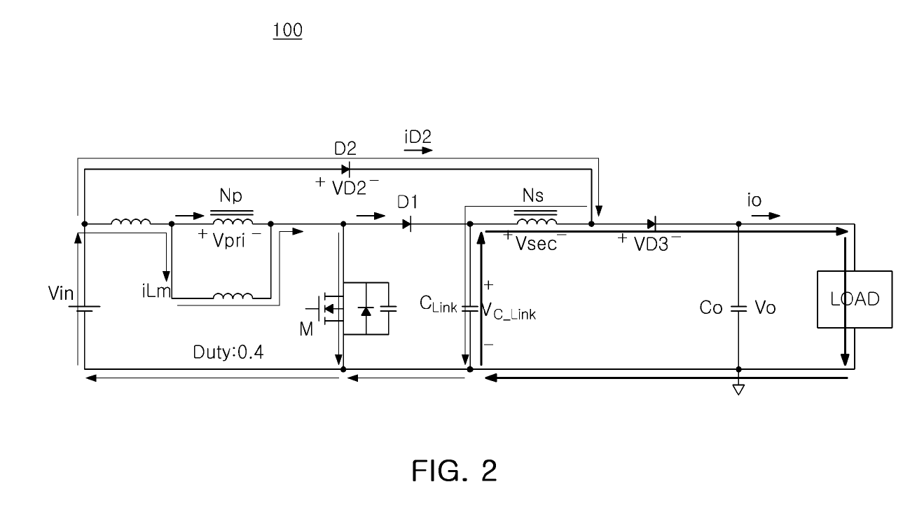

FIG. 2 is a view schematically illustrating current flowing in a boost converter according to an exemplary embodiment of the present invention.

With reference to FIG. 1 together with FIG. 2, the switch M of the boost converter 100 according to the embodiment of the invention is switched on or off according to a predetermined switching duty. Herein, power is transmitted through different paths when the switch M is switched on and when the switch M is switched off.

When the switch M is switched on, the power may be transmitted in a direction represented by a thin arrow in FIG. 2. When the switch M is switched off, the power may be transmitted in a direction represented by a bold arrow in FIG. 2.

That is, when the switch M is switched on, the input power Vin passes through a leakage inductor Lk and a magnetizing inductor Lm and is then applied to the switch M. The power passes through the second diode D2 and the secondary winding Ns and is transmitted to the link capacitor C_{Link}, and the link capacitor C_{Link} is charged with the transmitted power.

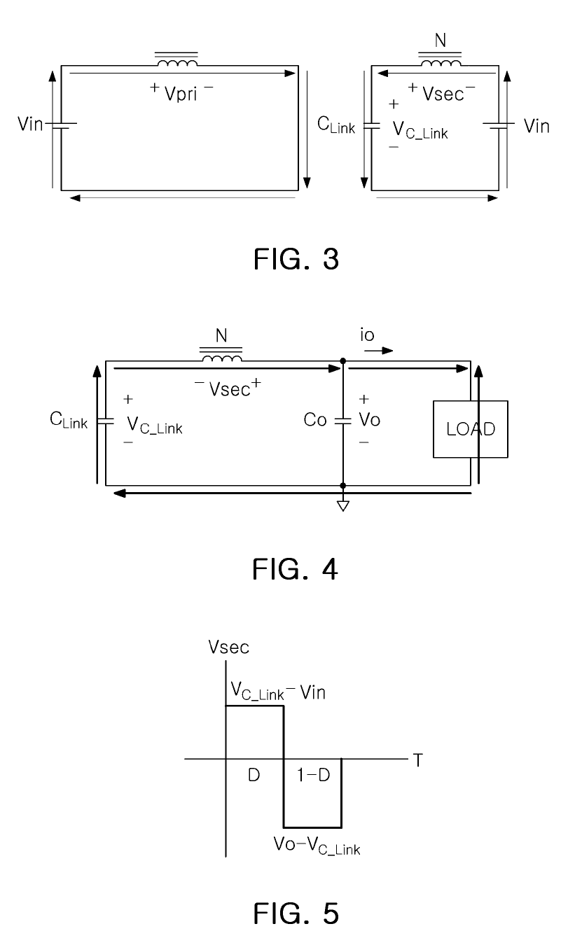

FIG. 3 is a view schematically illustrating current flowing in an equivalent circuit of a boost converter, when a switch is switched on, according to an exemplary embodiment of the present invention.

With reference to FIG. 3 together with FIGS. 1 and 2, when the switch M is switched on, the input power Vin is applied to the primary winding Np of the transformer 110, and thus a voltage Vpri of the primary winding Np is equal to a level of the input power Vin. The secondary winding Ns transmits input power nVin based on a turns ratio n with the primary winding Np to the link capacitor C_{Link}, and thus a voltage V_{C}_{_{—}}_{Link} of the link capacitor C_{Link} is equal to a voltage Vsec of the secondary winding Ns. A level of the voltage V_{C}_{_{—}}_{Link} is equal to the sum of the input power Vin and the input power nVin based on the turns ratio n.

Herein, in order for the first diode D1 to be turned on, the sum of the voltage Vsec of the secondary winding Ns and the voltage of the input power Vin should be larger than the voltage V_{C}_{_{—}}_{Link} of the link capacitor C_{Link}.

FIG. 4 is a view schematically illustrating current flowing in an equivalent circuit of a boost converter, when a switch is switched off, according to an exemplary embodiment of the present invention.

With reference to FIG. 4 together with FIGS. 1 and 2, when the switch M is switched off, the power charged in the link capacitor C_{Link} passes through the secondary winding Ns and the third diode D3 and is stabilized by the capacitor Co and then transmitted to a load.

FIG. 5 is a graph illustrating a voltage level applied to a secondary winding employed in a boost converter, when a switch is switched on and off, according to an exemplary embodiment of the present invention.

The voltage level of the power applied to the secondary winding Ns may be expressed by the following Equation 1, according to a switching duty D:

D(Vc_Link−Vin)=(1−D)(Vo−VC_Link) (Equation 1)

Here, when the voltage V_{C}_{_{—}}_{Link} of the link capacitor C_{Link} is replaced with the sum of the input power Vin and the input power nVin based on the turns ratio n, i.e., (Vin+nVin), the following Equation 2 is obtained:

Vin+nVin−DVin=Vo(1−D) (Equation 2)

Here, Equation 2 is written with respect to the voltage Vo of the output power stabilized by the capacitor Co, the following Equation 3 is obtained:

$$Vo = \frac{Vin + nVin - DVin}{1 - D} \qquad ( Equation 3 )$$

When Equation 3 is expressed by using the sum of the input power Vin and the input power nVin based on the turns ratio n, i.e., (Vin+nVin), the following Equation 4 is obtained:

$$Vin + nVin + X = \frac{Vin}{1 - D} + \frac{( n - D ) Vin}{1 - D} \qquad ( Equation 4 )$$

Here, Equation 4 is written with respect to the voltage Vo of the output power, the following Equation 5 is obtained:

$$Vo = Vin + nVin + \frac{nD}{1 - D} Vin \qquad ( Equation 5 )$$

On the basis of the above-described Equations, in order to obtain 120V as the voltage Vo of the output power by setting the voltage level of the input power to be 24V and setting the turns ratio n to be 2, the switching duty D may be set to be 0.5.

As described above, a boost converter according to the present invention is capable of reducing internal pressure in elements without the employment of a separate snubber by clamping a voltage, transmitted to the elements, to a charging voltage or an output voltage during power conversion.

As set forth above, a boost converter according to exemplary embodiments of the invention allows for a reduction of internal pressure in elements without the employment of a separate snubber by clamping a voltage, transmitted to the elements, to a charging voltage or an output voltage during power conversion. Accordingly, a reduction of power conversion efficiency by the snubber may be avoided, and elements having low internal pressure may be employed so that the manufacturing costs thereof can be reduced.

While the present invention has been shown and described in connection with the exemplary embodiments, it will be apparent to those skilled in the art that modifications and variations can be made without departing from the spirit and scope of the invention as defined by the appended claims.

What is claimed is:

1. A boost converter comprising:
a transformer including a primary winding receiving input power and a secondary winding electromagnetically coupled to the primary winding and having a predetermined turns ratio therewith;
a switching part allowing the input power transmitted to the primary winding to be on or off according to a predetermined switching duty;
a clamping part including a link capacitor charged with the input power obtained when the switching part is switched on, and power transformed based on the predetermined turns ratio; and
a stabilizing part stabilizing power outputted from the clamping part.

2. The boost converter of claim 1, wherein a sum of a voltage level of power magnetically induced from the primary winding to the secondary winding and a voltage level of the input power is greater than a voltage level of power charged in the link capacitor.

3. The boost converter of claim 1, wherein the transformer further comprises:
a leakage inductor series-connected between one end of the primary winding and one end of an input power terminal through which the input power is transmitted; and
a magnetizing inductor parallel-connected to one end and the other end of the primary winding.

4. The boost converter of claim 3, wherein the switching part comprises a switch connected between the other end of the primary winding and a ground, and
the clamping part further comprises:
a first diode having an anode connected to the other end of the primary winding and a cathode connected to one end of the secondary winding; and
a second diode having an anode connected to one end of the input power terminal and a cathode connected to the other end of the secondary winding.

5. The boost converter of claim 4, wherein the stabilizing part comprises:
a third diode having an anode connected to the other end of the secondary winding; and
a capacitor connected to a cathode of the third diode and the ground.

6. The boost converter of claim 1, wherein the primary winding and the secondary winding are wound in the same direction.
